(19) United States
(12) Patent Application Publication
(10) Pub. No.: US 2002/0022507 A1
(43) Pub. Date: Feb. 21, 2002

(54) Toy driving system and method using game program

(75) Inventors: Byung Ju Dan, Sungnam (KR); Jong Rak Lim, Yongin (KR); Jae Ho Na, Kuri (KR); Jang Won Boo, Seoul (KR); Hee Il Wang, Seoul (KR); Nam Woong Kim, Seoul (KR); In Sang Song, Ulwang (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 09/933,372

(22) Filed: Aug. 20, 2001

(30) Foreign Application Priority Data
Aug. 21, 2000 (KR) 2000-48364

(51) Int. Cl. A63F 13/00

(52) U.S. Cl. 463/1; 463/42

(57) ABSTRACT

The present invention is provided to solve the problem that the conventional cyber game on the basis of network decreases continuous interest of a user and sense for the real since a user can enjoy the game only in the cyber space and the toy driving system in accordance with the present invention comprises a toy driving system using a game program comprising a game program which is operated in the cyber space, including a cyber character, learning/growing toys corresponding to the cyber character, PC for outputting to the learning/growing toys the motion/voice command of the cyber character while a user operates the game program, embodying the motion/voice of the cyber character and outputting the intelligence/learning information according to the learned contents of the learning/growing toys, and a game server for outputting to the PC the command for embodying the motion/voice of the cyber character, receiving the intelligence/learning information and the game progress information of the learning/growing toys from the PC and reflecting the game progress information on game level of the game program. Also, the present invention connected-performs the cyber character and the toy of the user in a game in the virtual space and embodies the motion and voice. Accordingly, the toy user can have a feeling of the various condition which can be occurred in the game process, action and voice and the toy user can have the feeling of reality thus to attract a continuous interest.

### BACKGROUND OF THE INVENTION

1. Field of the Invention

The present invention relates to a toy driving system and method and particularly, to a toy driving system and method using a game program which embody to an actual toy certain command of a cyber character in a cyber game space.

2. Description of the Background Art

FIG. 1 is a block diagram showing a conventional PC game system, wherein a game program is stored. A user operates the game program in the cyber space by an independent PC 100 for displaying a game program on a monitor according to an operation command of the user. Namely, as the user selects a cyber character provided in the game program, the game program of determined story is operated online or offline.

FIG. 2 is a block diagram showing a game system on the basis of a conventional network. The game system comprises a game server 210 for storing various data files such as ID(Identification)s of respective users of the game program and a cyber character selected by the user, and supplying the data files to each user through the network according to the user's request, and PCs 2201˜220N for receiving the data files from the game server 210 as the user operates the game program and operating the game program in the cyber space.

After the user turn on the PC, the PCs 2201˜220N are connected to the game server 210 and by adjusting the cyber character selected by the user using a keyboard, joystick and voice, the game system on the basis of the network makes the user enjoy the game in the cyber space.

However, the conventional PC game system has a disadvantage that the user cannot have continuous interest on the cyber game since the user can enjoy the game only in the cyber space and accordingly, the user cannot give a feeling of reality or attract interest.

### SUMMARY OF THE INVENTION

Therefore, an object of the present invention is to provide a toy driving system and method using a game program which embodies to an actual toy a motion/voice of a cyber character in the game space in case the toy user operates the game program in the cyber space using the PC (Personal Computer).

Another object of the present invention is to make the user have the feeling of reality, while the game program is operated, by operating the cyber character in the game space using the actual toy and make the user feel a continuous attachment for the toy.

Still another object of the present invention is to embody various levels of game difficulty through diversification of the game progress status according to the learning/growing degree of the learning/growing toy in the cyber space.

To achieve these and other advantages and in accordance with the purpose of the present invention, as embodied and broadly described herein, there is provided a toy driving system using a game program comprising a game program which is operated in the cyber space, including a cyber character, learning/growing toys corresponding to the cyber character, PC for outputting to the learning/growing toys the motion/voice command of the cyber character while a user operates the game program, embodying the motion/voice of the cyber character and outputting the intelligence/learning information according to the learned contents of the learning/growing toys, and a game server for outputting to the PC the command for embodying the motion/voice of the cyber character, receiving the intelligence/learning information and the game progress information of the learning/growing toys from the PC and reflecting the game progress information on game level of the game program.

In the present invention, the apparatus for transmitting and receiving data about the game server, motion, voice, intelligence/learning information for the learning/growing toy can be embodied by an apparatus having wire and wireless communication functions, such as a PC, mobile phone and a PDA (Personal Digital Assistant).

Also, the user can transmit and receive the data about the game server, motion voice and intelligence/learning information without passing through the PC since the learning/growing toy can be connected to the Internet through the wire and wireless communication apparatus, namely, for performing function such as series port, parallel port and USB (Universal Serial Bus) or another communication port.

To achieve these and other advantages and in accordance with the purpose of the present invention, the method comprises the steps of judging whether the game program uses the cyber character or not in case of be operated the game, judging whether there is a command for embodying to an actual toy the motion/voice of the cyber character in the game space by the communication means in case the game uses a cyber character, and outputting the certain command to the learning/growing toy and embodying the certain command of the cyber character in case there is the certain command of the cyber character.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing a conventional PC game system;

FIG. 2 is a block diagram showing a game system on the basis of a conventional network;

FIG. 3 is a block diagram showing a game system in accordance with the present invention;

FIG. 4 is a block diagram showing a signal flow for the action of a learning/growing toy in accordance with the present invention;

FIG. 5 is a detail view showing an operation mapper included in a main controller of the learning/growing toy of FIG. 4.

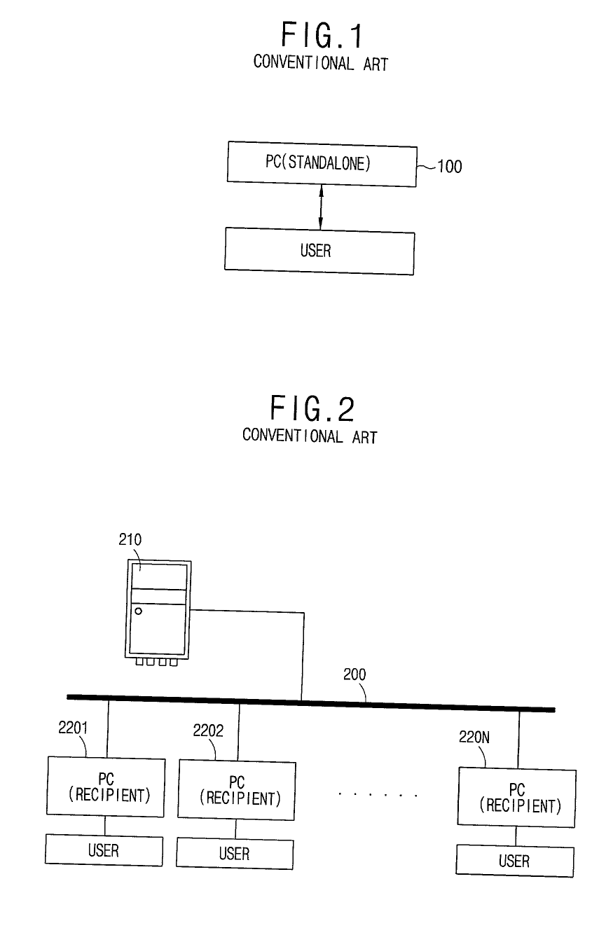

### DETAILED DESCRIPTION OF THE PREFERRED EMBODIMENTS

Reference will now be made in detail to the preferred embodiments of the present invention, examples of which are illustrated in the accompanying drawings.

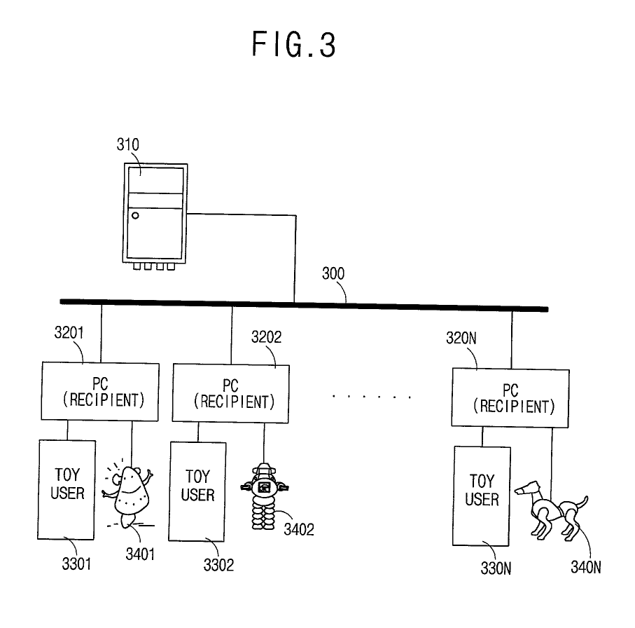

FIG. 3 is a block diagram showing a game system in accordance with the present invention.

As shown in the drawing, the game system in accordance with the present invention comprises a game program which is operated in the cyber space, including a cyber character, learning/growing toys 3301˜330N corresponding to the cyber character, PCs 3201˜320N for outputting the motion/voice command of the cyber character in the learning/growing toys 3301˜330N while a user operates the game program, embodying the motion/voice of the cyber character and outputting the intelligence/learning information according to the learned contents by the learning/growing toys 3301˜330N and a game server for outputting the command for embodying the motion/voice of the cyber character in the PCs 3201˜320N, receiving the intelligence/learning information and the game progress information of the learning/growing toys 3301˜330N from the PCs 3201˜320N and reflecting the game progress information on the game level of the game program.

In the present invention, the apparatus for transmitting and receiving data about the game server, motion, voice, and intelligence/learning information for the learning/growing toys 3301˜330N can be embodied by a performance apparatus having wire and wireless communication functions as those of PC, mobile phone or a PDA.

The actuation of the game system and operation effect in accordance with the present invention with the above composition will be described as follows.

The toy user operates a game such as a mug game by downloading the information data about the game after connecting to the game server 310. Here, the game information data includes information such as the cyber character corresponding to the learning/growing toys 3301˜330N selected by the user from the game server and a user ID. Later, the toy user selects the cyber character and then operates the cyber character using a keyboard, joystick or voice. While the user of each toy operates the game using the cyber character in the cyber space, the server 310 collects the game progress information from the PCs 3201˜320N and operates the cyber character in the cyber space by outputting the motion/voice command and game progress information to the PC 3201˜320N.

Later, respective PCs 3201˜320N exhibits the motion/voice which are identical with the those of the cyber character or which are specific by outputting the motion/voice command corresponding to the action of the cyber character to the learning/growing toys 3301˜330N. Accordingly, the respective learning/growing toys 3301˜330N store the motion/voice which are embodied by itself in the built-in memory and learned by the toy user or by itself continuously.

Then the respective learning/growing toys 3301˜330N reflect an item on the collection of the items of a game such as the roll playing game by outputting the intelligence/learning information according to the learned contents to the game server 310 through the PCs 3201˜320N. Also, if the user inputs a command such as voice or picture to the respective learning/growing toys 3301˜330N during the operation of the game, the command of the toy user for operating the game is outputted to the game server through the respective PCs 3201˜320N and accordingly, the user can operate the game without a direct adjustment of a mouse, joystick or a keyboard.

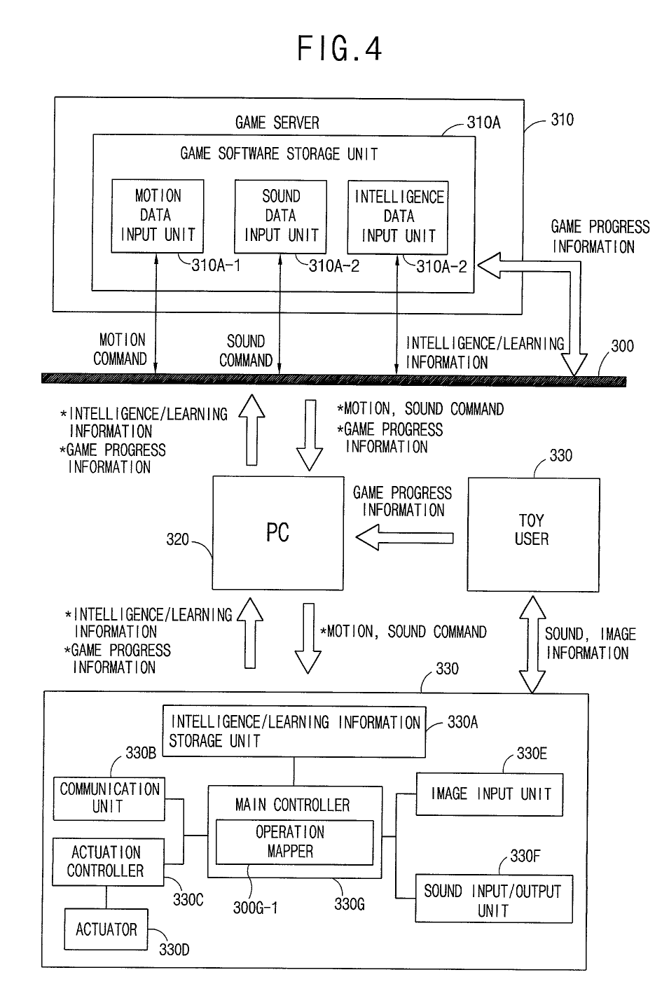

FIG. 4 is a block diagram showing a signal flow for the action of a learning/growing toy in accordance with the present invention.

Here, the FIG. 3 is a schematic overview composition which connects many toy users with the game server 301, but the FIG. 4 is a detailed composition which connects a toy user 330 with the game server 301.

As shown in the drawing, the game server 310 comprises a game software storage unit 310A which memorizes a certain command according to the cyber character in the game space while the game is operated.

The game software storage unit 310A is composed of a motion data input unit 310A-1 for generating a motion command for inputting to the cyber character, a sound data input unit 310A-2 for generating a voice command for inputting to the cyber character and a game software storage unit 310A which is composed of an intelligence data input unit 310A-3 for inputting the intelligence/learning information to the cyber character.

The game server 310 receives the game progress information and intelligence/learning information from the PC 320 through the Internet 300 and outputs the motion command, voice command and game progress information to the PC 320 through the Internet. While the toy user operates the game, the PC 320 outputs the motion command and the voice command of the game server 310 to the learning/growing toy 330 and receives the intelligence/learning information and game progress information from the learning/growing toy 330.

The learning/growing toy 330 comprises a intelligence/learning information storage unit 330A, a communication unit 330B for receiving the motion/voice from the PC 320, outputting to the PC 320 the intelligence/learning information and the game progress information, an actuation controller 330C for controlling an actuator 330D for embodying the certain motion, an image input unit 330E for inputting the picture information by the toy user, a voice input/output unit 330F for inputting/outputting the voice information by the toy user and the game server and a main controller 330G for controlling the actuation of all apparatuses of the learning/growing toy 330.

Here, since the learning/growing toy 330 can be connected to the Internet directly through the input/output apparatuses for inputting/outputting image, voice and letters data and wire and wireless communication apparatus, namely, a series port, parallel port and various communication ports for performing the same function, the learning/growing toy 330 can transmit and receive data about image, motion, voice, intelligence/learning information with the game server 310.

Firstly, if the motion/voice command is received from the above game server 310 through the PC 320, the actuator 330D is operated by the actuation controller 330C and accordingly, a certain motion/voice command is embodied. The information according to the embodied motion/voice command is stored in the intelligence/learning information storage unit 330A and then transmitted to the game server 310 again thus to be reflected on the progress of the game.

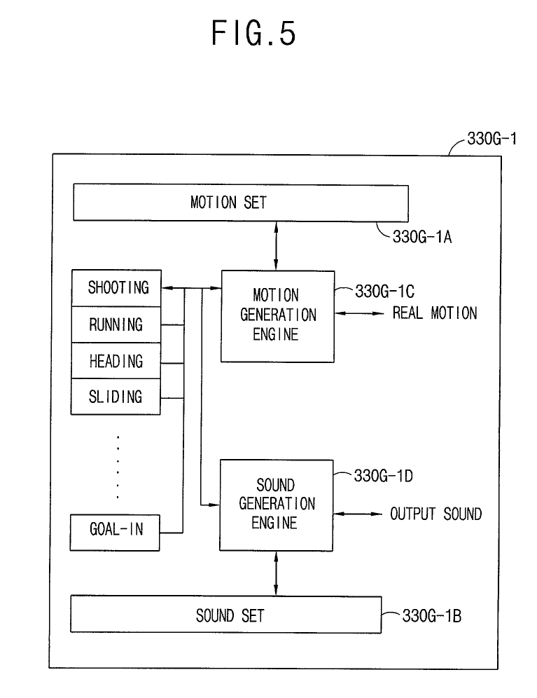

The block diagram of the main controller 330G is shown in FIG. 5 in detail.

FIG. 5 is a detail view showing an operation mapper included in a main controller of the learning/growing toy of FIG. 4.

The main controller 330G comprising an operation mapper 330G-1A which maps a certain command according to the event with a motion/voice according to the certain command in the inside of the learning/growing toy.

Here, the operation mapper 330G-1A, as shown in the drawing, comprises a motion generation engine 330G-1C for selecting the motion set 330G-1A for embodying a certain motion and a sound generation engine 330G-1D for selecting the sound set 330G-1B to embody a certain voice.

With reference to the drawings, the operation of the operation mapper 330G-1A will be described as follows.

Firstly, the user operates the game program by connecting to the game server on the Internet using the PC 320 and selecting the kind of game and cyber character. At this time, the game server 310 includes the game software which performed and connected with the learning/growing toy 330 and inputs the motion/voice command to the PC 320 through the Internet. Accordingly, in case the motion/voice command inputted from the game server 310 is inputted to the learning/growing toy 330 through the wire and wireless communication apparatuses between the PC 320 and the learning/growing toy 330, the main controller 330G performs conversion processing of the motion/voice command into a motion and voice and then embody the motion/voice command by the game server 310 into a certain motion/voice by controlling the actuation controller 330C and the voice input/output unit 330F.

Also, the learning/growing toy 330 stores its learned data to the intelligence/learning information storage unit 330A and outputs the data to the PC 320 through the communication unit 330B. The PC 320 outputs the intelligence/learning information of the learning/growing toy 330 to the game server 310 through the Internet. Accordingly, the game server 310 uses the intelligence/learning information inputted from the learning/growing toy 330 as a main factor for game progress while the game program is operated. For example, in case an item is collected, the intelligence/learning information of the learning/growing toy 330 is reflected on the item and accordingly, used as a standard for judging the probability of collection of the item.

Also, in case of operating the game, the toy user can progress the game progress command of the cyber character in the form of action and voice of the learning/growing toy 330. For example, in case of the network game of ‘FIFA 2000’, various events can be occurred and the actuation of the learning/growing toy 330 is operated by the operation mapper 330G-1 which is included in the main controller 330G of the learning/growing toy 330. Namely, if events such as shooting, running, heading are occurred in the network game of ‘FIFA 2000’, the motion generation engine 330G-1C and the sound generation engine 330G-1D which are included in the operation mapper 330G-1 of the learning/growing toy 330 select information corresponding to the inputted command in the motion set 330-1A and sound set 330G-1B receiving the motion/voice command of the game server 310 and output the information to the actuation controller 330C and the voice input/output unit 330F. Then the learning/growing toy 330 outputs various motion actions together with voice. That is, the operation mapper 330G-1, when event is occurred, maps a certain command according to the event with a motion/voice according to the certain command inside the learning/growing toy 330.

That is, in case a motion/voice command corresponding to shooting is inputted from the game server 310 during the game, the operation mapper 330G-1 selects and outputs the shooting motion trajectory and shooting sound from the motion set 330-1A and the sound set 330G-1B and accordingly, the learning/growing toy 330 can output the shooting action and corresponding voice.

Contrary to the process, if the toy user outputs command in the form of picture/voice through the picture input unit 330E and the voice input/output unit 330F of the learning/growing toy 330 or the command is inputted through various sensors, the operation mapper 330G-1 converts the commands to the motion/voice data corresponding to the command and output the data to the PC 320. The motion/voice data is inputted to the game server 310. The game server 310 receives the motion/voice data, embodies the corresponding motion in the cyber character and at the same time, outputs voice. Therefore, the toy user can play the game without adjusting the mouse, keyboard or joystick directly.

On the other hand, since the learning/growing toy in accordance with the present invention includes learning function and artificial intelligence function, the toy can grow by embodying motion and voice in the cyber character and learning by itself during the game progress in the cyber space.

In the present invention, the network game in the cyber space is not limited to just a game but it can be applied to almost all kinds of games and can be connected with the learning/growing toy.

As apparent from the above description, the present invention connected-performs the cyber character and the toy of the user in a game in the virtual space and embodies the motion and voice. Accordingly, the toy user can have a feeling of various condition which can be occurred in the game process, action and voice and the toy user can have the feeling of reality thus to attract a continuous interest.

Also, in the present invention, the learning/growing toy performs learning and operates the cyber character. Accordingly, the present invention can provides a network game with sense for the real and can compare toy operation freely and provoke competition.

Therefore, the present invention can create a new demand in the whole fields of industries of game/entertainment/robot/toy/mobile phone/PDA.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A toy driving system using a game program comprising:
a game program which is operated in the cyber space, including a cyber character;
learning/growing toy corresponding to the cyber character;
PC for outputting to the learning/growing toys the motion/voice command of the cyber character while a user operates the game program, embodying the motion/voice of the cyber character and outputting the intelligence/learning information according to the learned contents of the learning/growing toys; and
a game server for outputting to the PC the command for embodying the motion/voice of the cyber character, receiving the intelligence/learning information and the game progress information of the learning/growing toys from the PC and reflecting the game progress information on game level of the game program.

2. The system according to claim 1, wherein the PC operates the game program stored in the game server by downloading the game program including the cyber character and user' ID(Identification) corresponding to the learning/growing toys selected by the user from the game server through the Internet, or connecting to the game server.

3. A toy driving system using a game program comprising:
a game program which is operated in the cyber space, including a cyber character;
learning/growing toy corresponding to the cyber character;
a driving means for connecting the cyber character in the game space with the learning/growing toys, driving the cyber character and the learning/growing toys while the game program is operated by the user; and
a game server for outputting to the driving means a certain command of the cyber character, receiving the intelligence/learning information according to the learned contents of the learning/growing toys and game progress information from the driving means and reflecting on the game level of the game program.

4. The system according to claim 3, wherein the driving means operates the game program stored in the game server by downloading the game program including the cyber character and user' ID(Identification) corresponding to the learning/growing toys selected by the user from the game server through the Internet, or connecting to the game server.

5. The system according to claim 3, wherein the driving means outputs to the learning/growing toys a certain command of the cyber character in the game space and game progress information to learn/grow the learning/growing toys while the game program is operated.

6. The system according to claim 3, wherein the driving means collects the intelligence/learning information according to the learned contents of the learning/growing toys and game progress information while the game is operated for a certain time, and outputs the information in the game server.

7. The system according to claim 3, wherein the driving means is one of PC, mobile phone or a PDA(Personal Digital Assistant) which including wire and wireless communication functions.

8. The system according to claim 3, wherein the game server comprises a game software storage unit which memorizes a certain command according to the cyber character in the game space while the game is operated for a certain time.

9. The system according to claim 3, wherein the game software storage unit comprising:
a motion data input unit for generating a motion command for outputting to the cyber character;
a sound data input unit for generating a voice command for outputting to the cyber character; and
an intelligence data input unit for outputting the intelligence/learning information to the cyber character.

10. The system according to claim 3, wherein the learning/growing toy can embody a motion/voice/image according to just a promised command without having learning/growing function.

11. The system according to claim 3, wherein the learning/growing toy receives a certain motion/voice of the cyber character through the driving means, embody the motion/voice and is learned by the toy user or learn by itself on the basis of the certain motion/voice.

12. The system according to claim 3, wherein the learning/growing toy comprising:
a intelligence/learning information storage unit;
a communication unit for receiving the motion/voice from the PC, outputting to the PC the intelligence/learning information and the game progress information;
an actuation controller for controlling an actuator for embodying the certain motion;
an image input unit for inputting the picture information by the toy user;
a voice input/output unit for inputting/outputting the voice information by the toy user and the game server; and
a main controller for controlling the actuation of all apparatuses of the learning/growing toy.

13. The system according to claim 12, wherein the main controller comprising an operation mapper which maps a certain command according to the event with a motion/voice according to the certain command inside the learning/growing toy.

14. The system according to claim 12, wherein the operation mapper comprising:
a motion generation engine for selecting a motion set for embodying a certain motion in accordance with the present invention; and
a sound set for embodying a certain voice in accordance with the cyber character.

15. The system according to claim 3, wherein the learning/growing toy comprising:
an input means for inputting the image, voice and letters;
wire and wireless communication means for operating wire and wireless communication for receiving the motion/voice command of the cyber character and outputting the intelligence/learning information and the game progress information to the communication means;
a intelligence/learning information storage means for storing the learned contents learned by the toy user and/or the learned contents learned by a motion/voice command of the cyber character while the game is operated;
an actuation controlling means for controlling the actuator to embody a certain motion;
a voice input/output means for inputting/outputting the voice information by the toy user or the game server; and
a main controlling means for controlling the actuation of all the means of the learning/growing toy.

16. A toy driving method using a game program comprising the steps of:
judging whether the game program uses the cyber character or not in case of be operated the game;
judging whether there is a command for embodying to an actual toy the motion/voice of the cyber character in the game space by the communication means in case the game uses a cyber character; and
outputting the certain command to the learning/growing toy and embodying the certain command of the cyber character in case there is the certain command of the cyber character.

17. A toy driving method using a game program comprising the steps of:
judging whether the game program uses a cyber character or not in case of operating the game;
judging whether there is a command for embodying the motion/voice of the cyber character in the game space in case of using the cyber character;
outputting the certain command to the learning/growing toy and embodying the certain command of the cyber character in case there is a certain command of the cyber character; and
outputting to the game server the intelligence/learning information and game progress information in accordance with the contents learned by the learning/growing toy to reflect the information on the game level of the cyber character.

18. The method according to claim 17, wherein the step of outputting the intelligence/learning information and game progress information in accordance with the contents learned by the learning/growing toy further comprising the step of connecting the Internet directly through input/output apparatuses for inputting/outputting image, voice and letters data and wire and wireless communication apparatus, namely, a series port, parallel port and various communication ports for performing the same function without passing through the communication means.

19. The method according to claim 17, wherein the step of:
outputting the intelligence/learning information and game progress information in accordance with the contents learned by the learning/growing toy further comprising the steps of:
outputting the picture/voice command to the picture input unit and the voice input/output unit of the learning/growing toy or receiving a certain command through various sensors by the learning/growing toy;
outputting to the communication means the picture/voice command and the certain command to reflect them on the game level of the cyber character; and
embodying the corresponding motion in the cyber character by receiving the data according to the picture/voice command and the certain command and at the same time, outputting the voice.

20. A toy driving method using a game program comprising the steps of:
receiving the motion/voice command in case an event is generated in a cyber game on the basis of the network and when the motion generation engine and sound generation engine of the learning/growing toy select the information corresponding to the command inputted in the motion set for embodying a certain motion and the sound set for embodying a certain voice and inputting the motion/voice command to the actuation controller for controlling the actuator and the voice input output unit for inputting/outputting the voice information by the toy user and the voice information by the game server; and
outputting the motion command inputted from the actuation controller, various motion action according to the voice command inputted from the voice input/output unit and the corresponding voice.
